(19) United States
(12) Patent Application Publication
(10) Pub. No.: US 2026/0282182 A1
(43) Pub. Date: Sep. 17, 2026

(54) MICROWAVE HEATING APPARATUS

(71) Applicant: POSTECH RESEARCH AND BUSINESS DEVELOPMENT FOUNDATION, Pohang-si (KR)

(72) Inventors: Hyunsang HWANG, Pohang-si (KR); Jongseon SEO, Pohang-si (KR)

(73) Assignee: POSTECH RESEARCH AND BUSINESS DEVELOPMENT FOUNDATION, Pohang-si (KR)

(21) Appl. No.: 19/450,389

(22) Filed: Jan. 15, 2026

(30) Foreign Application Priority Data
Mar. 12, 2025 (KR) 10-2025-0031975
Nov. 18, 2025 (KR) 10-2025-0175007

(51) Int. Cl. H05B 6/74; H05B 6/64; H05B 6/70

(52) U.S. Cl. CPC H05B 6/74; H05B 6/6402; H05B 6/707

(57) ABSTRACT

Disclosed is a microwave heating apparatus. The microwave heating apparatus comprises a cavity configured for microwaves to resonate; a first waveguide connected to one side of the cavity and supplying microwaves; and a second waveguide connected to the other side of the cavity and supplying microwaves, the first waveguide and the second waveguide being arranged such that respective central axes thereof are spaced apart from each other by at least a predetermined distance, and microwaves incident from the first and second waveguides generating constructive interference and destructive interference inside the cavity to form a uniform distribution of an electric field.

### CROSS-REFERENCE TO RELATED APPLICATION

This application claims priority under 35 U.S.C § 119 to Korean Patent Application No. 10-2025-0031975, filed on Mar. 12, 2025, and Korean Patent Application No. 10-2025-0175007, filed on Nov. 18, 2025, in the Korean Intellectual Property Office, the entire contents of each of which are hereby incorporated by reference.

### TECHNICAL FIELD

The present disclosure relates to a microwave heating apparatus, and more particularly, to a microwave heating apparatus capable of making an electric field distribution within a heating region uniform.

### BACKGROUND

In a semiconductor process, microwave heating is a technique of performing heat treatment by directly generating heat inside a material in a non-contact manner by inducing dielectric loss or conductive loss inside a wafer or a thin-film material by using electromagnetic waves in a microwave frequency band.

However, when a spatial distribution of an electric field is non-uniform during microwave heating, overheating (Hot Spot) may occur in a specific region, and underheating (Cold Spot) may occur in another region, resulting in problems such as degradation of process uniformity, deterioration of material quality, and energy loss.

Therefore, securing uniformity of the electric field distribution is very important in securing efficiency and reliability of a microwave heating process.

### SUMMARY

The problem to be solved by the present disclosure is to provide a microwave heating apparatus capable of securing intensity and uniformity of an electric field within a heating region through constructive interference and destructive interference, and capable of expanding an area of a uniform heating region through the same.

A problem to be solved according to an embodiment of the present disclosure is not limited to the problem mentioned above, and other problems not mentioned may be clearly understood by those skilled in the art from the description below.

A microwave heating apparatus according to an embodiment of the present disclosure comprises a cavity configured for microwaves to resonate; a first waveguide connected to one side of the cavity and supplying microwaves; and a second waveguide connected to the other side of the cavity and supplying microwaves, the first waveguide and the second waveguide being arranged with respective central axes spaced apart from each other by at least a predetermined distance, thereby generating constructive interference and destructive interference by microwaves incident from the first and second waveguides inside the cavity and forming a uniform distribution of an electric field.

According to embodiments of the present disclosure, by including a first waveguide and a second waveguide that are respectively connected to one side and the other side of a cavity and are arranged such that respective central axes thereof are spaced apart from each other by at least a predetermined distance on a plane, intensity and uniformity of an electric field within a heating region may be secured through constructive interference and destructive interference.

In addition, intensity and uniformity of the electric field within the heating region may be improved through adjustment of the spacing distance between the first and second waveguides and optimization of a size and a divergence angle of the cavity, and an area of a region capable of uniform heating may be expanded through the same.

In addition, intensity of the electric field may be maximized by setting the spacing distance between the central axes of the first and second waveguides to a position at which a ratio (max/min ratio) of a maximum value to a minimum value of the electric field formed by constructive interference in a central region of the cavity becomes minimum.

In addition, in order to prevent an antinode and a node from being reformed in a central region of the cavity, uniformity of an electric field distribution may be secured by setting a distance from both end portions to which the first and second waveguides are connected to an edge of the cavity positioned in the central region to be less than or equal to one-half of an effective wavelength of microwaves.

In addition, uniformity of the electric field distribution may be further improved by setting a divergence angle formed toward the central region from the first and second waveguides to a range that suppresses occurrence of a side lobe.

In addition, heating efficiency may be improved by securing intensity of the electric field and uniformity of the electric field distribution.

Further, since microwave energy is uniformly distributed over an entire front surface of a wafer or a heating target, thermal stress caused by local overheating or temperature deviation during annealing after a doping process may be reduced.

In addition, the present disclosure may be utilized not only in a semiconductor process but also in various application fields such as household and commercial microwave ovens, medical thermotherapy equipment, chemical reactions, and material processing. By increasing energy efficiency and minimizing heating non-uniformity in this way, an effective solution capable of simultaneously achieving energy saving and quality improvement may be provided.

In addition to the effects described above, specific effects of the present disclosure may be clearly understood while describing embodiments below.

### BRIEF DESCRIPTION OF THE DRAWINGS

FIG. 1 is a perspective view illustrating a microwave heating apparatus according to an embodiment of the present disclosure.

FIG. 2 is a plan view illustrating a microwave heating apparatus according to an embodiment of the present disclosure.

FIG. 3 is a front view illustrating a microwave heating apparatus according to an embodiment of the present disclosure.

FIG. 4 is a view for explaining constructive interference in a microwave heating apparatus according to an embodiment of the present disclosure.

FIG. 5 is a view for explaining parameters in a structure of a microwave heating apparatus according to an embodiment of the present disclosure.

FIG. 6 is a graph illustrating a range of an electromagnetic field distribution when a spacing distance of a first waveguide and a second waveguide is set to a position at which a ratio (max/min ratio) of a maximum value to a minimum value of an electric field becomes minimum in the structure of FIG. 5.

FIG. 7 is a graph illustrating a cavity size associated with an effective wavelength of microwaves in the structure of FIG. 5.

FIG. 8 illustrates simulation results in which an electric field distribution is changed as a divergence angle of a cavity increases in the structure of FIG. 5.

FIG. 9 is a graph illustrating an optimal divergence angle of a cavity to minimize an influence of a side lobe associated with microwave propagation in the structure of FIG. 5.

FIG. 10 is a graph illustrating a region in which an electric field is uniformly distributed when applying the structure of FIG. 5.

FIGS. 11 to 14 are views illustrating temperature distribution results when annealing a wafer by using a microwave heating apparatus according to an embodiment of the present disclosure.

### DETAILED DESCRIPTION

The above-described objects, means, and effects will be described in detail below with reference to the accompanying drawings, and thus, a person having ordinary skill in the art to which the present disclosure pertains may easily implement the technical spirit of the present disclosure. In the description of the present disclosure, detailed descriptions of known technologies related to the present disclosure will be omitted when it is determined that such descriptions may unnecessarily obscure the gist of the present disclosure. Hereinafter, embodiments of the present disclosure will be described in detail with reference to the accompanying drawings. The same reference numerals in the drawings are used to refer to identical or similar components.

Hereinafter, a microwave heating apparatus capable of securing intensity and uniformity of an electric field in a heating region through constructive interference and destructive interference and capable of expanding an area of a uniform heating region through the same is disclosed.

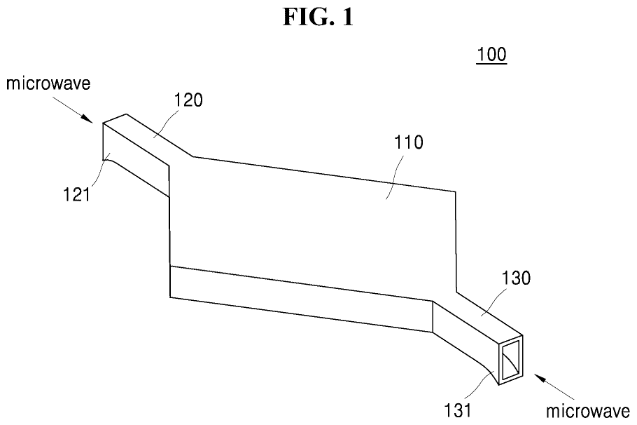

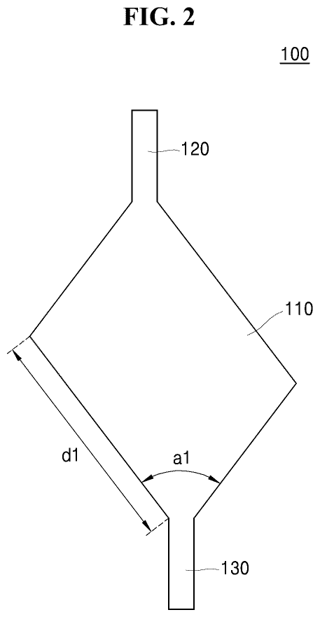

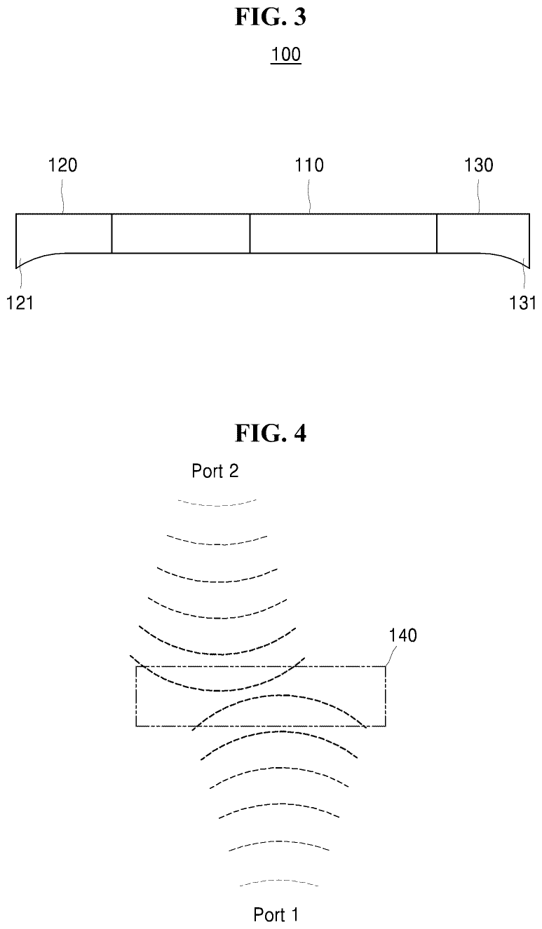

FIG. 1 is a perspective view illustrating a microwave heating apparatus according to an embodiment of the present disclosure. FIG. 2 is a plan view illustrating a microwave heating apparatus according to an embodiment of the present disclosure. FIG. 3 is a front view illustrating a microwave heating apparatus according to an embodiment of the present disclosure.

Referring to FIGS. 1 to 3, a microwave heating apparatus 100 according to an embodiment of the present disclosure comprises a cavity 110, a first waveguide 120, and a second waveguide 130.

The cavity 110 is a space for heating a target, and serves to confine microwaves inside the cavity and cause the microwaves to resonate. For example, the cavity 110 may be formed as an enclosed space made of a metal material.

The cavity 110 may be formed such that a cross-sectional area thereof gradually increases toward a central region from both end portions to which the first waveguide 120 and the second waveguide 130 are connected. For example, the cavity 110 may be formed in a parallelepiped shape.

The first waveguide 120 may be connected to one side of the cavity 110 to allow microwaves to flow into the cavity 110. The second waveguide 130 may be connected to the other side of the cavity 110 to allow microwaves to flow into the cavity 110.

By supplying microwaves from both sides of the cavity 110 in this way, constructive interference and destructive interference may occur in a central region of the cavity 110, thereby forming a more uniform distribution of an electric field. Accordingly, a distribution of an electric field intensity in the heating region may be stably maintained, and temperature uniformity may be improved.

A central axis of the first waveguide 120 and a central axis of the second waveguide 130 may be arranged to be spaced apart from each other by at least a predetermined distance on a plane. For example, the spaced-apart arrangement may be set to a position at which a ratio (max/min ratio) of a maximum value to a minimum value of an electric field formed in the central region of the cavity 110 is minimized. In another example, a spacing distance between the central axes may be set to a value greater than a width of the first waveguide 120 and a width of the second waveguide 130.

That is, by optimizing a spacing distance between the central axes, intensity of an electric field in a central region may be maximized while securing a uniform electric field distribution. As a result, a spaced-apart arrangement on a plane may control interference effects inside the cavity 110 and may improve electric field intensity and uniformity.

In addition, in order to prevent an antinode and a node from being reformed in the central region of the cavity 110, a distance from both end portions of the cavity 110 to which the first waveguide 120 and the second waveguide 130 are connected to an edge positioned in the central region may be set to less than or equal to ½ of an effective wavelength of microwaves. Accordingly, repeated formation of a standing-wave pattern is suppressed, and local concentration or absence of an electric field is prevented.

In addition, uniformity of an electric field distribution may be secured by limiting a divergence angle formed toward the central region from the first waveguide 120 and the second waveguide 130 to within a range in which a side lobe does not occur. For example, a divergence angle of the cavity 110 may be set to 65° to 80°.

In addition, the first waveguide 120 and the second waveguide 130 may be formed such that an inlet cross-sectional area is greater than an outlet cross-sectional area based on a microwave propagation direction. Alternatively, an opening cross-sectional area may be formed to gradually decrease from an inlet toward an outlet. In addition, a lower surface may have a curved shape.

For example, the first waveguide 120 and the second waveguide 130 may be formed such that a lower end portion of a lower surface on a side to which microwaves are incident protrudes downward. In this case, a first protrusion 121 may be formed in the first waveguide 120, and a second protrusion 131 may be formed in the second waveguide 130.

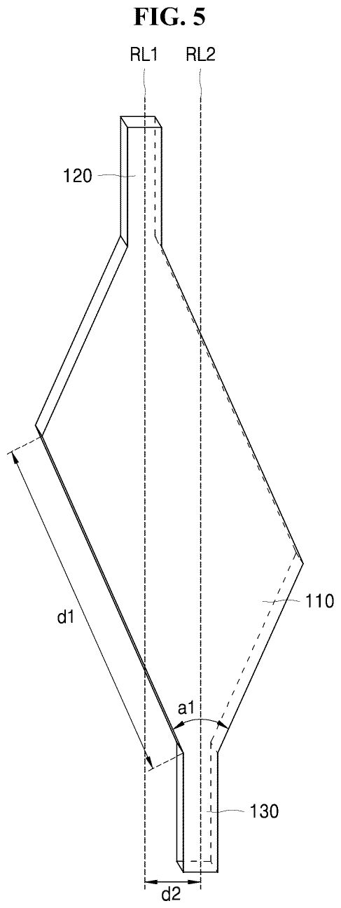

FIG. 4 is a view for explaining constructive interference in a microwave heating apparatus according to an embodiment of the present disclosure. FIG. 5 is a view for explaining parameters in a structure of a microwave heating apparatus according to an embodiment of the present disclosure.

Referring to FIGS. 4 and 5, a structure of the microwave heating apparatus 100 according to an embodiment of the present disclosure will be described in detail as follows.

A space for resonating microwaves is formed inside the cavity 110. An electric field may be formed inside the cavity 110 by microwaves incident through the first waveguide 120 and the second waveguide 130. At this time, microwaves incident through the first waveguide 120 and the second waveguide 130 may form a uniform electric field distribution by generating constructive interference and destructive interference in a central region.

In addition, by arranging the central axes RL1 and RL2 of the first waveguide 120 and the second waveguide 130 to be spaced apart from each other, constructive interference may be maximized inside the cavity 110. A reference numeral 140 in FIG. 4 indicates a central region in which constructive interference and destructive interference occur between the first microwave and the second microwave.

When the first microwave and the second microwave are incident into the cavity 110 through the first waveguide 120 and the second waveguide 130, constructive interference due to superposition of the two microwaves may occur inside the cavity 110, and heating efficiency may be improved through the same.

In this way, the microwave heating apparatus 100 may maximize constructive interference of microwaves incident through the first and second waveguides 120 and 130 and may improve heating efficiency by connecting the first and second waveguides 120 and 130 to the cavity 110 such that central axes thereof are spaced apart from each other.

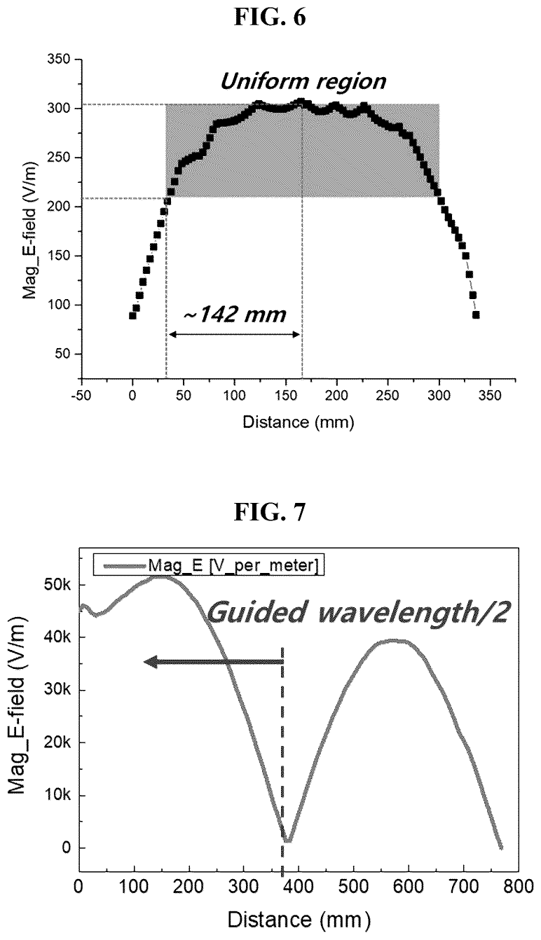

FIG. 6 is a graph illustrating a range of an electromagnetic field distribution when a spacing distance d2 of the first and second waveguides is set to a position at which a ratio (max/min ratio) of a maximum value to a minimum value of an electric field becomes minimum in the structure of FIG. 5. FIG. 7 is a graph illustrating a cavity size associated with an effective wavelength of microwaves in the structure of FIG. 5.

A spacing distance d2 between the central axes RL1 and RL2 of the first waveguide 120 and the second waveguide 130 may be set to a position capable of minimizing a ratio (max/min ratio) of a maximum value to a minimum value of an electric field formed by constructive interference occurring in a central region of the cavity 110.

In addition, the cavity 110 may be set such that a distance d1 from one end portion of a parallelepiped connected to the first waveguide 120 to an edge of the parallelepiped and a distance d1 from the other end portion of the parallelepiped connected to the second waveguide 130 to an edge of the parallelepiped are each less than or equal to one-half of an effective wavelength λ of microwaves. For example, the distance d1 may be set to approximately 380 mm or less.

An opening connected to the first waveguide 120 may be formed at one edge of the cavity 110, and an opening connected to the second waveguide 130 may be formed at the other edge. At this time, a shape of the opening may be formed to be the same as a cross-sectional shape of the first and second waveguides 120 and 130.

A size of the cavity 110 may be optimized such that nodes and antinodes associated with a half-wavelength λ/2 of microwaves are not reformed, and non-uniformity of an electric field distribution may be prevented through the same.

The first waveguide 120 and the second waveguide 130 may have spaces formed therein for microwaves to propagate and may be formed to have the same length. For example, the first waveguide 120 may be connected to one edge of the cavity 110, and the second waveguide 130 may be connected to the other edge of the cavity 110.

In addition, lower end portions of lower surfaces of the first and second waveguides 120 and 130 may protrude downward, and for example, a first protrusion 121 may be formed at the lower end portion of the lower surface of the first waveguide 120, and a second protrusion 131 may be formed at the lower end portion of the lower surface of the second waveguide 130.

The first and second waveguides 120 and 130 may be formed of the same material as the cavity 110 or of different materials from each other, and may be formed to be integrally formed with the cavity 110 or to be attachable and detachable.

Microwaves may each be applied to the first and second waveguides 120 and 130 from a microwave generator (not shown), and at this time, the two microwaves may have the same phase.

The microwave generator may apply microwaves having a predetermined frequency f, wavelength λ, and power to the first and second waveguides 120 and 130. For example, the frequency f may be in a range of 300 MHz to 300 GHz, and the wavelength λ may be in a range of approximately 1.0 mm to 1.0 m. In addition, the microwave generator may adjust the frequency, wavelength, and power according to heating characteristics of the microwave heating apparatus 100.

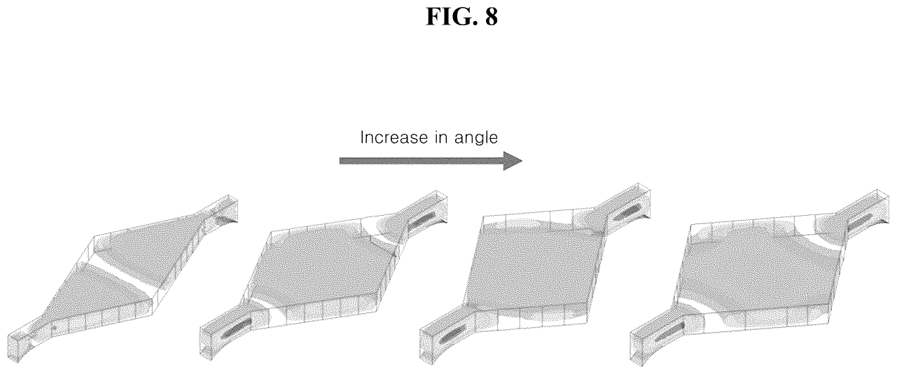

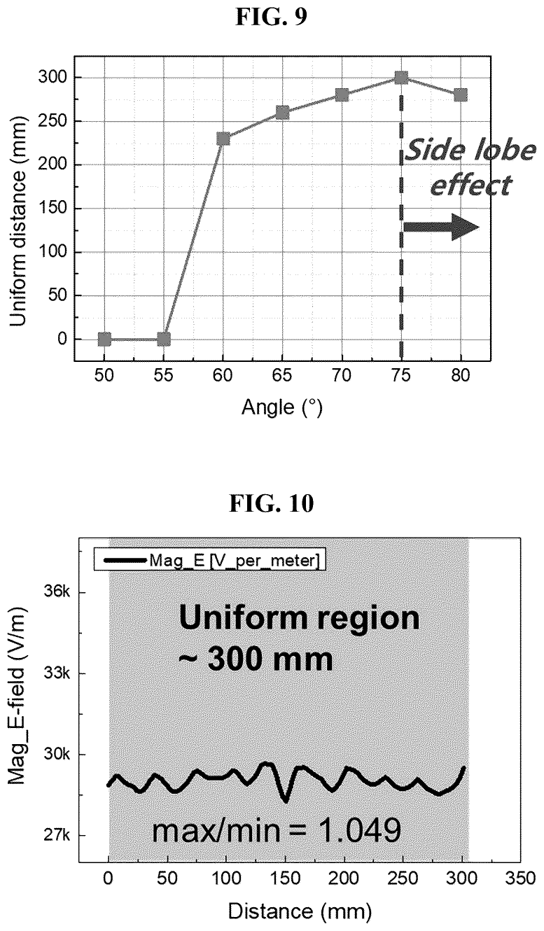

FIG. 8 illustrates simulation results in which an electric field distribution is changed as a divergence angle of the cavity increases in the structure of FIG. 5. FIG. 9 is a graph illustrating an optimal divergence angle of a cavity to minimize an influence of a side lobe associated with microwave propagation in the structure of FIG. 5.

Referring to FIGS. 8 and 9, for example, the cavity 110 may form angles a1 of two faces of a parallelepiped connected to the first waveguide 120 and angles a1 of two faces of the parallelepiped connected to the second waveguide 130 to be angles between 65° and 80°. Here, an angle a1 may be defined as a divergence angle at which microwaves are diverged from the first and second waveguides 120 and 130 toward the cavity 110.

It may be confirmed that a range of a uniform distribution of an electric field expands as the divergence angle increases. On the other hand, it was confirmed that when the divergence angle exceeds 80°, a side lobe occurs and uniformity of the electric field deteriorates. Accordingly, a divergence angle of the cavity 110 according to the present embodiment may be optimally designed in a range of 65° to 80°.

FIG. 10 is a graph illustrating a region in which a uniform electric field distribution is formed inside the cavity when applying the structure of FIG. 5.

According to the present disclosure, the first and second waveguides 120 and 130 are arranged to supply microwaves to the cavity 110 at positions in which respective central axes thereof are spaced apart from each other, and constructive interference is dominantly formed in a central region of the cavity.

Accordingly, a uniform electric field distribution in which a ratio (max/min ratio) of a maximum value to a minimum value of the electric field is almost equal to 1 may be implemented, and referring to FIG. 10, it may be confirmed that a uniform heating region is formed for a region having a diameter of 300 mm.

Therefore, uniform heating performance in which temperature deviation between a central portion and a peripheral portion of a heating target is extremely small may be secured even without a rotating tray or a stirring mechanism.

As described above, the present disclosure may implement a very uniform electric field distribution over a range of up to approximately 300 mm inside the cavity 110 by adjusting a spacing distance between the central axes of the first and second waveguides 120 and 130 and optimizing a size and a divergence angle of the cavity 110.

According to these embodiments, energy loss may be minimized and uniform heating may be performed with a small amount of power through a uniform electric field distribution, thereby maximizing heating efficiency. In addition, overheating or low-temperature region occurrence may be suppressed, thereby improving heating uniformity. In addition, uniform heating may be realized without a complicated mechanism such as a rotating tray, thereby enabling design simplification and cost reduction.

In addition, non-uniform electric field distribution formation may be prevented by limiting a size of the cavity 110 to less than or equal to one-half of a wavelength of microwaves. Furthermore, an influence of a side lobe may be minimized by optimizing a divergence angle of the cavity 110 to an angle between 65° and 80°. Through a design according to the present embodiment, both a central portion and an edge portion of a heating target may be uniformly heated, and energy-efficient heating may be enabled even without a rotating device.

By optimizing positions of the first and second waveguides 120 and 130, adjusting a size of the cavity 110, and adjusting a divergence angle, a uniform electric field distribution in a range of approximately 300 mm inside the cavity may be implemented, thereby maximizing heating efficiency and uniformity.

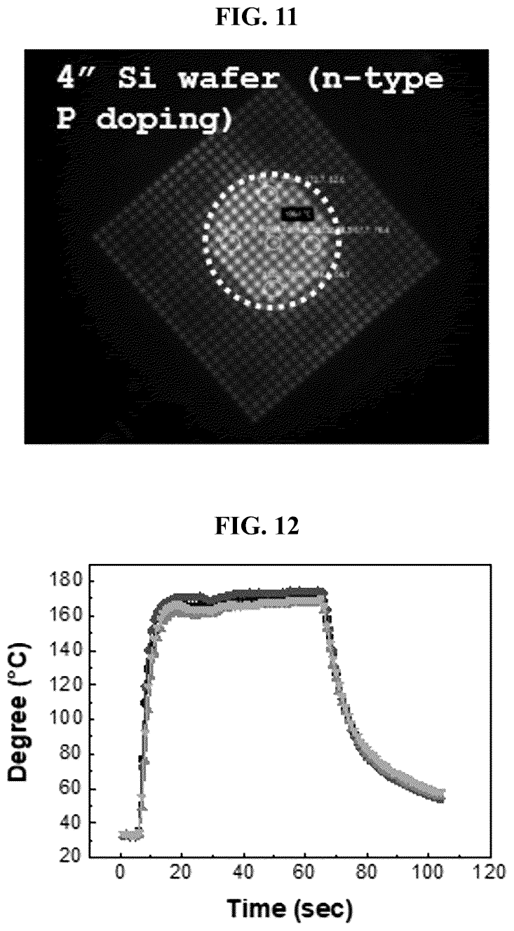

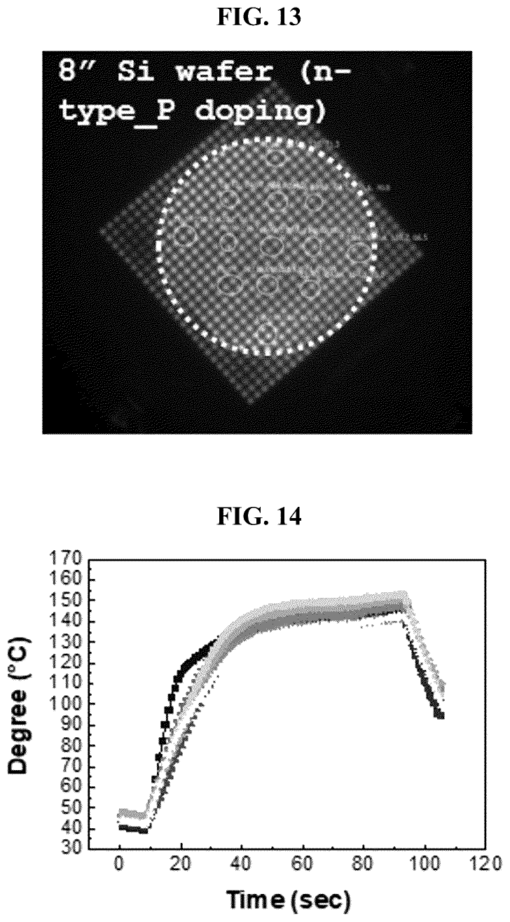

FIGS. 11 to 14 are views illustrating temperature distribution results when annealing a wafer by using a microwave heating apparatus according to an embodiment of the present disclosure. FIG. 11 illustrates a 4-inch silicon wafer, and FIG. 13 illustrates an 8-inch silicon wafer. As a result of performing an annealing process on an n-type doped silicon wafer by using the apparatus of the present disclosure, a uniform temperature distribution in which a difference between a maximum temperature and a minimum temperature is less than approximately 9° C. was formed in both cases.

As described above, since microwave energy is uniformly distributed over an entire surface of a wafer according to the present disclosure, thermal stress caused by local overheating or temperature deviation may be reduced and occurrence of crystal defects may be suppressed. In addition, diffusion of a doping profile may be minimized, thereby securing stability of fine structures such as a PN junction.

A uniform temperature distribution may contribute to securing uniformity of device characteristics and improving precision of subsequent processes (for example, metal wiring, insulating film formation, and the like), and may be applicable to latest semiconductor devices having high thermal sensitivity (for example, FinFET, GAA, and the like), thereby being effective in improving reliability and yield of a low-temperature process.

A microwave heating apparatus according to an embodiment of the present disclosure comprises a cavity configured for microwaves to resonate; a first waveguide connected to one side of the cavity and supplying microwaves; and a second waveguide connected to the other side of the cavity and supplying microwaves, the first waveguide and the second waveguide being arranged with respective central axes spaced apart from each other by at least a predetermined distance, thereby generating constructive interference and destructive interference by microwaves incident from the first and second waveguides inside the cavity and forming a uniform distribution of an electric field.

According to an embodiment, a spacing distance between central axes of the first waveguide and the second waveguide may be set to a position at which a ratio (max/min ratio) of a maximum value to a minimum value of an electric field formed by constructive interference in a central region of the cavity becomes minimum.

According to an embodiment, the cavity may be formed such that a cross-sectional area thereof gradually increases toward a central region from both end portions to which the first waveguide and the second waveguide are connected.

According to an embodiment, a divergence angle of the cavity may be formed in a range of 65° to 80° and may be set to minimize occurrence of a side lobe and secure uniformity of the electric field.

According to an embodiment, the cavity may be set such that a distance from both end portions to which the first waveguide and the second waveguide are connected to a cavity edge located in the central region is less than or equal to one-half of an effective wavelength of microwaves so as to prevent an antinode and a node from being reformed in the central region.

According to an embodiment, the first waveguide and the second waveguide may be formed such that an inlet cross-sectional area is greater than an outlet cross-sectional area based on a microwave propagation direction, an opening cross-sectional area gradually decreases from an inlet toward an outlet, and a lower surface is formed to have a curved shape.

According to an embodiment, microwaves incident through the first waveguide and the second waveguide may be controlled to have the same phase.

According to an embodiment, the cavity may be formed of a metal material or may be formed of the same material as or a different material from the first and second waveguides, and the first and second waveguides may be formed to be integrated with the cavity or to be attachable and detachable.

According to an embodiment, the cavity may be formed such that a cavity size and a divergence angle are optimized so that microwaves incident through the first and second waveguides maintain electric field uniformity in a central region.

According to an embodiment, the cavity in combination with the first and second waveguides may be designed such that uniform heating is enabled both at a central portion and a peripheral portion of a heating target even without a rotating tray.

Although the present disclosure has been described above with reference to the illustrated drawings by way of example, it is apparent that the present disclosure is not limited to the embodiments and drawings disclosed in the present specification, and that various modifications may be made by a person having ordinary skill in the art within the scope of the technical idea of the present disclosure. In addition, even if the operational effects according to the configuration of the present disclosure are not explicitly described when describing the above embodiments of the present disclosure, predictable effects resulting from the configuration must also be recognized.

1. A microwave heating apparatus, comprising:
a cavity configured for microwaves to resonate;
a first waveguide connected to one side of the cavity and supplying microwaves; and
a second waveguide connected to the other side of the cavity and supplying microwaves,
wherein the first waveguide and the second waveguide are arranged with respective central axes spaced apart from each other by at least a predetermined distance, and microwaves incident from the first and second waveguides generate constructive interference and destructive interference inside the cavity to form a uniform distribution of an electric field.

2. The microwave heating apparatus according to claim 1,
wherein a spacing distance between a central axis of the first waveguide and a central axis of the second waveguide is set to a position at which a ratio (max/min ratio) of a maximum value to a minimum value of an electric field formed by constructive interference in a central region of the cavity becomes minimum.

3. The microwave heating apparatus according to claim 1,
wherein the cavity is formed such that a cross-sectional area thereof gradually increases toward a central region from both end portions to which the first waveguide and the second waveguide are connected.

4. The microwave heating apparatus according to claim 3,
wherein a divergence angle of the cavity is formed in a range of 65 degrees to 80 degrees so as to minimize occurrence of side lobes and secure uniformity of an electric field.

5. The microwave heating apparatus according to claim 3,
wherein, in order to prevent antinodes and nodes from being reformed in a central region, a distance from both end portions of the cavity to which the first waveguide and the second waveguide are connected to a cavity edge located in the central region is set to be less than or equal to one-half of an effective wavelength of microwaves.

6. The microwave heating apparatus according to claim 1,
wherein the first waveguide and the second waveguide are formed such that an inlet cross-sectional area thereof is greater than an outlet cross-sectional area thereof based on a microwave propagation direction, an opening cross-sectional area gradually decreases from an inlet toward an outlet, and a lower surface is formed to have a curved shape.

7. The microwave heating apparatus according to claim 1,
wherein microwaves incident through the first waveguide and the second waveguide are controlled to have the same phase.

8. The microwave heating apparatus according to claim 1,
wherein the cavity is formed of a metal material or formed of a material identical to or different from materials of the first and second waveguides, and the first and second waveguides are formed integrally with the cavity or formed to be attachable and detachable.

9. The microwave heating apparatus according to claim 1,
wherein the cavity is formed with a cavity size and a divergence angle optimized such that microwaves incident through the first and second waveguides maintain uniformity of an electric field in a central region.

10. The microwave heating apparatus according to claim 1,
wherein the cavity in combination with the first and second waveguides is designed to enable uniform heating both at a central portion and a peripheral portion of a heating target even without a rotating tray.
